(19) United States
(12) Patent Application Publication
(10) Pub. No.: US 2026/0151305 A1
(43) Pub. Date: Jun. 4, 2026

(54) APPARATUS FOR THE ORAL DELIVERY OF LIQUID MEDICATION FOR HUMAN AND VETERINARY USE

(71) Applicant: DANIELA MINTENKO, Irvine, CA (US)

(72) Inventor: DANIELA MINTENKO, Irvine, CA (US)

(21) Appl. No.: 19/454,658

(22) Filed: Jan. 21, 2026

Related U.S. Application Data
(63) Continuation-in-part of application No. 18/734,975, filed on Jun. 5, 2024, now Pat. No. 12,551,412.

(51) Int. Cl. A61J 7/00; A61D 7/00; A61J 1/20

(52) U.S. Cl. CPC A61J 7/0053; A61D 7/00; A61J 1/2037; A61J 1/2093; A61J 7/0007; A61J 7/0038; A61J 7/0046

(57) ABSTRACT

Disclosed is a method, and/or an apparatus for the oral delivery of liquid medication for human and veterinary use. An oral delivery apparatus includes a primary fluid chamber to contain a consumable liquid. A secondary medication chamber contains a medication while remaining physically isolated from the primary fluid chamber. An isolation structure is positioned between the primary fluid chamber and the secondary medication chamber to maintain a default non-mixing state during handling. A controlled mixing mechanism is operatively associated with the isolation structure to establish fluid communication between the primary fluid chamber and the secondary medication chamber upon activation. A retention assembly is associated with the secondary medication chamber to maintain fixed axial positioning and fixed rotational orientation relative to the oral delivery apparatus during use. The oral delivery apparatus supports controlled administration of medication concurrent with liquid consumption while preserving separation prior to activation.

### CLAIM OF PRIORITY

This Application is a Continuation-In-Part Application of, and claims priority to, and incorporates by reference herein the entirety of the disclosure of co-pending U.S. patent application Ser. No. 18/734,975 titled-BABY BOTTLE WITH SYRINGE RECEIVER filed on Jun. 5, 2024.

### FIELD OF TECHNOLOGY

This disclosure relates generally to oral delivery of consumable liquid substances and, more particularly, to delivery of medication during oral intake by human and/or animal recipients.

### BACKGROUND

Parents, caregivers, healthcare providers, and animal handlers frequently encounter difficulties when attempting to administer liquid medication and supplements in a controlled and reliable manner. Difficulties may include, but may not be limited to, infant care, care of elderly individuals, persons with physical or cognitive impairments, and animals requiring oral dosing, including pets and livestock. A common challenge in oral administration environments may include limited control over timing and manner of introduction of medication into a consumable fluid. Premature mixing may occur during preparation, transport, storage, and handling. Premature mixing may result in inaccurate dosing, chemical degradation of medication, and unintended exposure to medicated fluid prior to an administration event.

Oral administration may involve insufficient separation between a medicated substance and a primary fluid prior to administration. Movement, agitation, inversion, and repositioning of a container may cause unintended leakage and mixing. Inconsistent delivery and spillage may occur during feeding and consumption, particularly during mobile care activities and extended administration intervals. Positional instability may occur during oral intake, particularly during movement, handling, or consumption, resulting in unintended displacement or misalignment during administration. Leakage, inconsistent delivery rates, and improper administration may result. Risk of instability may increase during movement by a recipient or caregiver, including infants, elderly individuals, individuals with limited motor control, and animals.

Precise dosing may present further difficulty during oral delivery of medicated fluids. Lack of coordination between initiation of fluid consumption and release of medication may hinder accurate delivery of an intended quantity. Orientation of a container, unintended release, and accidental actuation during handling may contribute to dosing inconsistency. Differences in feeding behaviours, oral anatomy, physical capability, and care environments among various populations may complicate oral administration and reduce consistency during dosing. Variability among infants, elderly individuals, disabled individuals, and animals may further increase challenges during oral delivery. During transport and non-use conditions, absence of safeguards during non-administration periods may allow unintended exposure, release, and contact with medicated substances. Risk of accidental interaction may increase in environments involving children, elderly individuals, and animals.

### SUMMARY

Disclosed are a method, and/or an apparatus for the oral delivery of liquid medication for human and veterinary use.

In one aspect, an oral delivery apparatus includes a primary fluid chamber to contain a consumable liquid. The oral delivery apparatus includes a secondary medication chamber to contain a medication. The secondary medication chamber is physically isolated from the primary fluid chamber. The oral delivery apparatus includes an isolation structure positioned between the primary fluid chamber and the secondary medication chamber. The isolation structure maintains a default non-mixing state during handling. The oral delivery apparatus includes a controlled mixing mechanism operatively associated with the isolation structure. The controlled mixing mechanism establishes fluid communication between the primary fluid chamber and the secondary medication chamber upon activation of the controlled mixing mechanism. The oral delivery apparatus includes a retention assembly associated with the secondary medication chamber. The retention assembly maintains the secondary medication chamber in a fixed axial position and a fixed rotational orientation relative to the oral delivery apparatus during use. The oral delivery apparatus includes a mouthpiece positioned at an upper portion of the oral delivery apparatus configured to be received in a mouth of a user to deliver consumable liquid for oral consumption.

The oral delivery apparatus may include the isolation structure includes a physical barrier. The physical barrier may prevent contact between the medication and the consumable liquid prior to activation of the controlled mixing mechanism. The oral delivery apparatus may include the controlled mixing mechanism includes a suction-responsive mechanism, a pressure-responsive mechanism, and/or a mechanical release mechanism. The controlled mixing mechanism may include a mixing valve positioned between the primary fluid chamber and the secondary medication chamber. The mixing valve may remain closed prior to activation. The mixing valve may open upon activation to permit controlled transfer of the medication. The retention assembly may include an axial stop limiting insertion depth of the secondary medication chamber. The retention assembly may include a rotational alignment feature preventing misorientation of the secondary medication chamber. The retention assembly may include a locking interface selected from a snap-fit interface, a threaded interface, a bayonet interface, and/or a detent interface.

The secondary medication chamber may be removable and replaceable independently of the primary fluid chamber. The oral delivery apparatus may include a leak-resistant seal. The leak-resistant seal may maintain the default non-mixing state during non-use. The oral delivery apparatus may further include a pill crusher positioned on the oral delivery apparatus. The pill crusher may mechanically crush a solid medication prior to placement within the secondary medication chamber. The pill crusher may be detachable from the oral delivery apparatus. The detachable pill crusher may permit transfer of crushed medication into the secondary medication chamber through a transfer port. The pill crusher may be integrated into the upper portion of the oral delivery apparatus. The secondary medication chamber may be in fluid communication with an internal conduit configured to deliver the medication toward a mixing region adjacent the mouthpiece while bypassing the primary fluid chamber. The internal conduit and the controlled mixing mechanism may be configured to deliver an intended dose of the medication independently of a remaining volume of the consumable liquid in the primary fluid chamber.

In another aspect, a method of administering a medication during oral consumption of a liquid includes maintaining a medication within a secondary medication chamber physically isolated from a primary fluid chamber of an oral delivery apparatus. The method includes preserving a default non-mixing state between the medication and the liquid during handling. The method includes activating a controlled mixing mechanism in response to oral consumption to establish fluid communication between the secondary medication chamber and the primary fluid chamber. The method further includes delivering the medication together with the liquid following activation while maintaining the secondary medication chamber in a fixed axial position and a fixed rotational orientation relative to the oral delivery apparatus.

The method may further include activating the controlled mixing mechanism by generating oral suction through a mouthpiece of the oral delivery apparatus and/or applying pressure to the oral delivery apparatus during oral consumption. The method may further include preserving the default non-mixing state by preventing fluid communication through a mixing valve prior to activation of the controlled mixing mechanism. The method may further include delivering the medication in a controlled dose synchronized with activation of the controlled mixing mechanism during oral consumption of the liquid. The method may further include maintaining the secondary medication chamber in the fixed axial position and the fixed rotational orientation by mechanically restraining the secondary medication chamber relative to the oral delivery apparatus throughout activation and delivery of the medication. The method may further include mechanically crushing a solid medication using a pill crusher prior to transferring the medication into the secondary medication chamber.

In yet another aspect, an oral delivery apparatus includes a primary fluid chamber to contain a consumable liquid and a secondary medication chamber to contain a medication. The secondary medication chamber is physically isolated from the primary fluid chamber. The oral delivery apparatus includes a pill crusher to mechanically crush a solid medication prior to transfer of crushed medication into the secondary medication chamber. The oral delivery apparatus includes an isolation structure positioned between the primary fluid chamber and the secondary medication chamber, the isolation structure maintaining a default non-mixing state during handling. The oral delivery apparatus includes a controlled mixing mechanism includes a mixing valve positioned between the primary fluid chamber and the secondary medication chamber and operatively associated with the isolation structure to establish fluid communication between the primary fluid chamber and the secondary medication chamber upon activation. The oral delivery apparatus further includes a retention assembly associated with the secondary medication chamber to maintain the secondary medication chamber in a fixed axial position and a fixed rotational orientation relative to the oral delivery apparatus during use.

The oral delivery apparatus may further include the pill crusher includes an integrated structure coupled to an upper portion of the oral delivery apparatus. The pill crusher may further include a detachable structure separable from the oral delivery apparatus to transfer crushed medication into the secondary medication chamber. The oral delivery apparatus may further include a removable storage compartment coupled to a lower portion of the oral delivery apparatus by a threaded coupling, a snap-fit coupling, a bayonet coupling, and/or a detent coupling to store medication prior to administration. The oral delivery apparatus may further include a reversible cap selectively attachable to an upper portion and a lower portion of the oral delivery apparatus by a threaded interface, a snap-fit interface, a bayonet interface, and/or a detent interface for storage, sealing, and/or sanitation.

The mixing valve of the controlled mixing mechanism may remain closed to prevent fluid communication between the primary fluid chamber and the secondary medication chamber during storage, handling, and transport and may open only upon activation to permit transfer of the medication. The retention assembly may include an axial stop limiting insertion depth of the secondary medication chamber and a rotational alignment feature preventing rotation of the secondary medication chamber relative to the oral delivery apparatus during use. The secondary medication chamber may remain removable from the oral delivery apparatus while the isolation structure maintains the default non-mixing state, thereby preventing contact between the medication and the consumable liquid during removal and replacement of the secondary medication chamber.

The oral delivery apparatus may further include a handle coupled to the oral delivery apparatus to permit controlled positioning and stabilization of the oral delivery apparatus during oral administration to a human and an animal. The secondary medication chamber may further include a custom syringe assembly, the custom syringe assembly including a volume, a geometry, and/or a dispensing profile for oral administration to the human and/or the animal.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is an apparatus view of an oral delivery apparatus illustrating a main body, a body cap, and a mouthpiece, according to one embodiment.

FIG. 2 is an exploded view of the oral delivery apparatus of FIG. 1 illustrating a primary fluid chamber and a secondary medication chamber maintained in a physically isolated arrangement by an isolation structure, according to one embodiment.

FIG. 3 is an exploded view of the oral delivery apparatus of FIG. 1 illustrating insertion of the secondary medication chamber into the main body and engagement with a retention assembly, according to one embodiment.

FIG. 4 is a cross-sectional view of the oral delivery apparatus of FIG. 1 showing a controlled mixing state in which a mixing valve is positioned between the primary fluid chamber and the secondary medication chamber, according to one embodiment.

FIG. 5 is an exploded view of the oral delivery apparatus of FIG. 1 illustrating the interface between the body cap, the mouthpiece, the isolation structure, and the secondary medication chamber, according to one embodiment.

FIG. 6 is an apparatus view of an exemplary embodiment of the oral delivery apparatus of FIG. 1 illustrating a pill crusher and a handle, according to one embodiment.

FIG. 7 is an apparatus view of the oral delivery apparatus of FIG. 1 illustrating the pill crusher detached from the oral delivery apparatus, according to one embodiment.

FIG. 8 is an apparatus view of the oral delivery apparatus of FIG. 1 illustrating a removable storage compartment coupled to a lower portion of the main body, according to one embodiment.

FIG. 9 is an apparatus view of the oral delivery apparatus of FIG. 1 illustrating a reversible cap selectively coupled to an upper portion and alternatively coupled to the lower portion of the main body, according to one embodiment.

FIG. 10 is an apparatus view of the oral delivery apparatus of FIG. 1 illustrating, the mouthpiece, the primary fluid chamber, the secondary medication chamber, and a handle, according to one embodiment.

FIG. 11A is a conceptual view illustrating an infant administration use case of the oral delivery apparatus of FIG. 1, according to one embodiment.

FIG. 11B is a conceptual view illustrating an adult administration use case of the oral delivery apparatus of FIG. 1, according to one embodiment.

FIG. 11C is a conceptual view illustrating an animal administration use case of the oral delivery apparatus of FIG. 10, according to one embodiment.

Other features of the present embodiments will be apparent from the accompanying drawings and from the detailed description that follows.

### DETAILED DESCRIPTION

Example embodiments, as described below, may be used to provide a method, and/or an apparatus for the oral delivery of liquid medication for human and veterinary use.

In one embodiment, an oral delivery apparatus 100 includes a primary fluid chamber 202 to contain a consumable liquid. The oral delivery apparatus 100 includes a secondary medication chamber 204 to contain a medication. The secondary medication chamber 204 is physically isolated from the primary fluid chamber 202. The oral delivery apparatus 100 includes an isolation structure 206 positioned between the primary fluid chamber 202 and the secondary medication chamber 204. The isolation structure 206 maintains a default non-mixing state during handling. The oral delivery apparatus 100 includes a controlled mixing mechanism operatively associated with the isolation structure 206. The controlled mixing mechanism establishes fluid communication between the primary fluid chamber 202 and the secondary medication chamber 204 upon activation of the controlled mixing mechanism. The oral delivery apparatus 100 includes a retention assembly 302 associated with the secondary medication chamber 204. The retention assembly 302 maintains the secondary medication chamber 204 in a fixed axial position and a fixed rotational orientation relative to the oral delivery apparatus 100 during use. The oral delivery apparatus 100 includes a mouthpiece 106 positioned at an upper portion 904 of the oral delivery apparatus 100 configured to be received in a mouth of a user 1102 to deliver consumable liquid for oral consumption.

The oral delivery apparatus 100 may further include the isolation structure 206 comprising a physical barrier preventing contact between the medication and the consumable liquid prior to activation of the controlled mixing mechanism. The oral delivery apparatus 100 may further include the controlled mixing mechanism comprising a suction-responsive mechanism, a pressure-responsive mechanism, and/or a mechanical release mechanism. The controlled mixing mechanism may further include a mixing valve 208 positioned between the primary fluid chamber 202 and the secondary medication chamber 204. The mixing valve 208 may remains closed prior to activation and opens upon activation to permit controlled transfer of the medication. The retention assembly 302 may include an axial stop limiting insertion depth of the secondary medication chamber 204, a rotational alignment feature preventing misorientation of the secondary medication chamber 204, and/or a locking interface selected from a snap-fit interface, a threaded interface, a bayonet interface, and/or a detent interface. The secondary medication chamber 204 may be removable and replaceable independently of the primary fluid chamber 202. The oral delivery apparatus 100 may further include a leak-resistant seal 402 maintaining the default non-mixing state during non-use.

The oral delivery apparatus 100 may further include a pill crusher 602 positioned on the oral delivery apparatus 100 to mechanically crush a solid medication prior to placement within the secondary medication chamber 204. The pill crusher 602 may include a detachable structure to transfer crushed medication into the secondary medication chamber 204. The pill crusher 602 may further include an integrated structure positioned at the upper portion 904 of the oral delivery apparatus 100. The secondary medication chamber 204 may be in fluid communication with an internal conduit configured to deliver the medication toward a mixing region adjacent the mouthpiece 106 while bypassing the primary fluid chamber 202. The internal conduit and the controlled mixing mechanism may be configured to deliver an intended dose of the medication independently of a remaining volume of the consumable liquid in the primary fluid chamber 202.

In another embodiment, a method of administering a medication during oral consumption of a liquid includes maintaining a medication within a secondary medication chamber 204 physically isolated from a primary fluid chamber 202 of an oral delivery apparatus 100. The method includes preserving a default non-mixing state between the medication and the liquid during handling. The method includes activating a controlled mixing mechanism in response to oral consumption to establish fluid communication between the secondary medication chamber 204 and the primary fluid chamber 202. The method includes delivering the medication together with the liquid following activation while maintaining the secondary medication chamber 204 in a fixed axial position and a fixed rotational orientation relative to the oral delivery apparatus 100.

The method may further include activating the controlled mixing mechanism by generating oral suction through a mouthpiece 106 of the oral delivery apparatus 100 and/or applying pressure to the oral delivery apparatus 100 during oral consumption. The method may further include preserving the default non-mixing state by preventing fluid communication through a mixing valve 208 prior to activation of the controlled mixing mechanism. The method may further include delivering the medication in a controlled dose synchronized with activation of the controlled mixing mechanism during oral consumption of the liquid. The method may further include mechanically restraining the secondary medication chamber 204 relative to the oral delivery apparatus 100 throughout activation and delivery of the medication. The method may further include mechanically crushing a solid medication using a pill crusher 602 prior to transferring the medication into the secondary medication chamber 204.

In yet another embodiment, an oral delivery apparatus 1000 includes a primary fluid chamber 202 to contain a consumable liquid and a secondary medication chamber 204 to contain a medication. The secondary medication chamber 204 is physically isolated from the primary fluid chamber 202. The oral delivery apparatus 1000 includes a pill crusher 602 to mechanically crush a solid medication prior to transfer of crushed medication into the secondary medication chamber 204. The oral delivery apparatus 1000 includes an isolation structure 206 positioned between the primary fluid chamber 202 and the secondary medication chamber 204 maintaining a default non-mixing state during handling. The oral delivery apparatus 1000 includes a controlled mixing mechanism including a mixing valve 208 positioned between the primary fluid chamber 202 and the secondary medication chamber 204 operatively associated with the isolation structure 206 to establish fluid communication upon activation. The oral delivery apparatus 1000 includes a retention assembly 302 associated with the secondary medication chamber 204 maintaining fixed axial positioning and fixed rotational orientation during use.

The oral delivery apparatus 1000 may further include a removable storage compartment 804 coupled to a lower portion 802 of the oral delivery apparatus 1000 to store medication prior to administration. The oral delivery apparatus 1000 may further include a reversible cap 902 selectively attachable to an upper portion 904 and a lower portion 802 of the oral delivery apparatus 1000 for storage, sealing, and/or sanitation. The mixing valve 208 may remains closed during storage, handling, and/or transport and opens upon activation to permit transfer of the medication. The secondary medication chamber 204 may remains removable from the oral delivery apparatus 1000 while the isolation structure 206 maintains the default non-mixing state. The oral delivery apparatus 1000 may further include a handle 1002 coupled to the oral delivery apparatus 1000 to permit controlled positioning and stabilization during oral administration to a human and/or an animal. The secondary medication chamber 204 may further include a custom syringe assembly, the custom syringe assembly including a volume, a geometry, and/or a dispensing profile for oral administration to the human and/or the animal.

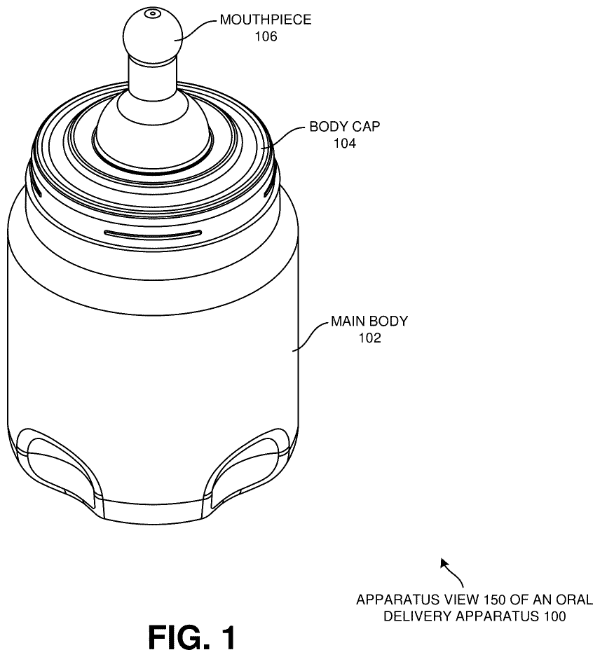

FIG. 1 is an apparatus view 150 of an oral delivery apparatus 100 illustrating a main body 102, a body cap 104, and a mouthpiece 106, according to one embodiment. FIG. 1 illustrates an oral delivery apparatus 100, a main body 102, a body cap 104, and a mouthpiece 106, according to one embodiment.

The main body 102 may be a lower structural portion of the oral delivery apparatus 100 and may present an external surface adapted for grasping, stabilizing, and supporting the oral delivery apparatus 100 during oral use. The external surface of the main body 102 may include contours, recesses, and/or surface features promoting secure manual handling.

The main body 102 may include an internal volume arranged to hold a consumable liquid during feeding operations. The main body 102 may maintain external rigidity sufficient to resist deformation during handling, transport, and feeding, while accommodating internal liquid containment without leakage under normal operating conditions.

The main body 102 may include an upper opening arranged to receive the body cap 104 in a secured arrangement. The main body 102 may further provide a structural reference along a longitudinal axis extending upward toward the mouthpiece 106, thereby supporting axial alignment of components during assembly and use, according to one embodiment.

The body cap 104 may be a structural component arranged to couple an upper portion of the main body 102 with the mouthpiece 106. The body cap 104 may form an intermediate housing element positioned circumferentially around an upper opening of the main body 102. The body cap 104 may be positioned at an upper portion of the main body 102 and may function as a mechanical interface between the main body 102 and the mouthpiece 106. The body cap 104 may extend circumferentially around the upper opening of the main body 102.

The body cap 104 may include mating surfaces engaging corresponding surfaces of the main body 102 to promote mechanical stability during handling and feeding. The body cap 104 may maintain positional alignment between the main body 102 and the mouthpiece 106 along the longitudinal axis of the oral delivery apparatus 100.

The body cap 104 may further support sealing engagement limiting leakage during non-use, transport, and oral consumption. The body cap 104 may assist in retaining internal components positioned below the body cap 104 while maintaining separation between internal regions and the external environment, according to one embodiment.

The mouthpiece 106 may be an oral interface component arranged to contact a mouth during feeding operations. The mouthpiece 106 may be formed as an elongated protruding structure extending upward from the body cap 104.

The mouthpiece 106 may extend upward from the body cap 104 and may define an oral interface adapted for engagement with a mouth during feeding. The mouthpiece 106 may present a geometry shaped to support oral placement while permitting controlled intake of liquid. The mouthpiece 106 may permit application of oral suction during consumption of a liquid. The mouthpiece 106 may maintain fluid communication with internal regions of the oral delivery apparatus 100 through an opening aligned with the body cap 104.

The mouthpiece 106 may cooperate with the body cap 104 to preserve axial alignment and sealing integrity during repeated oral use. The mouthpiece 106 may further support consistent delivery conditions during feeding while maintaining structural stability relative to the main body 102, according to one embodiment.

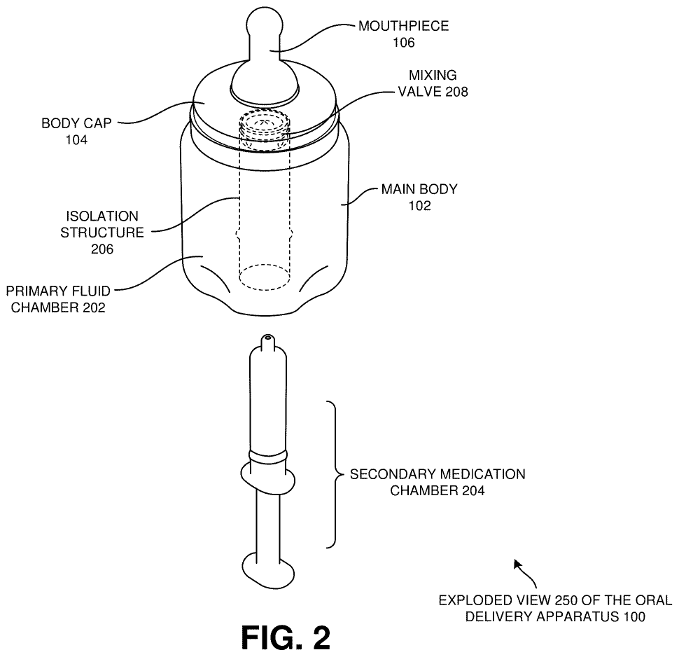

FIG. 2 is an exploded view 250 of the oral delivery apparatus 100 illustrating a primary fluid chamber 202 and a secondary medication chamber 204 maintained in a physically isolated arrangement by an isolation structure 206, according to one embodiment. FIG. 2 illustrates the main body 102, the body cap 104, the mouthpiece 106, a primary fluid chamber 202, a secondary medication chamber 204, an isolation structure 206, and a mixing valve 208, according to one embodiment.

The primary fluid chamber 202 may be an internal liquid-receiving region positioned within the main body 102. The primary fluid chamber 202 may occupy an internal volume surrounding a centrally positioned region of the oral delivery apparatus 200.

The primary fluid chamber 202 may receive and retain a consumable liquid during handling, storage, transport, and oral use. The primary fluid chamber 202 may remain physically separated from the secondary medication chamber 204 by the isolation structure 206.

The primary fluid chamber 202 may enter selective fluid communication with the secondary medication chamber 204 through the mixing valve 208 during controlled operating conditions. The primary fluid chamber 202 may cooperate with the mouthpiece 106 to permit delivery of liquid during oral consumption, according to one embodiment.

The secondary medication chamber 204 may be a medication-containing component positioned along the longitudinal axis of the oral delivery apparatus 200. The secondary medication chamber 204 may extend upward into the main body 102 from a lower region of the oral delivery apparatus 200.

The secondary medication chamber 204 may store a medication in an isolated condition relative to the primary fluid chamber 202. The secondary medication chamber 204 may maintain axial alignment with the mixing valve 208.

The secondary medication chamber 204 may permit controlled release of medication upon activation while remaining physically separated from the consumable liquid during handling and non-use. The secondary medication chamber 204 may cooperate with the isolation structure 206 to preserve a non-mixing condition prior to activation, according to one embodiment.

The isolation structure 206 may be a physical separation structure positioned between the primary fluid chamber 202 and the secondary medication chamber 204. The isolation structure 206 may extend along a central passage region within the main body 102.

The isolation structure 206 may prevent contact between the consumable liquid and the medication during handling, transport, and non-use. The isolation structure 206 may define a physical boundary maintaining separation between internal regions.

The isolation structure 206 may cooperate with the mixing valve 208 to regulate transition between separation and fluid communication. The isolation structure 206 may maintain a default non-mixing condition while permitting controlled communication during oral use, according to one embodiment.

The mixing valve 208 may be a flow-regulating component positioned between the primary fluid chamber 202 and the secondary medication chamber 204. The mixing valve 208 may be arranged near an upper region of the secondary medication chamber 204, adjacent to the body cap 104.

The mixing valve 208 may control fluid communication by maintaining a closed condition during handling and opening during oral activation. The mixing valve 208 may regulate transfer of medication toward the primary fluid chamber 202.

The mixing valve 208 may enable controlled dosing by limiting the rate and timing of medication transfer. The mixing valve 208 may cooperate with oral suction and/or pressure conditions applied through the mouthpiece 106, according to one embodiment.

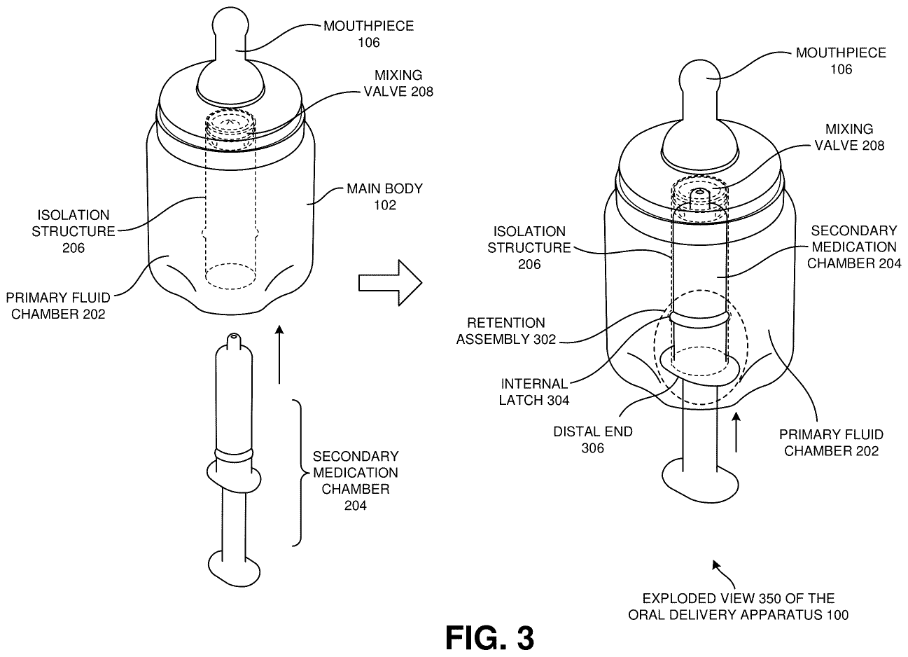

FIG. 3 is an exploded view 350 illustrating insertion of the secondary medication chamber 204 into the main body 102 and engagement with a retention assembly 302, according to one embodiment. FIG. 3 illustrates the main body 102, the body cap 104, the mouthpiece 106, the primary fluid chamber 202, the secondary medication chamber 204, the isolation structure 206, the mixing valve 208, a retention assembly 302, an internal latch 304, and a distal end 306, according to one embodiment.

The retention assembly 302 may be a mechanical engagement structure positioned within the main body 102 along a central longitudinal axis of the oral delivery apparatus 300. The retention assembly 302 may include but not limited to engagement surfaces, resilient members, rigid stops, and/or alignment features arranged to interact directly with the secondary medication chamber 204 during upward insertion.

The retention assembly 302 may establish a fixed axial position of the secondary medication chamber 204 relative to the main body 102 by limiting insertion depth once a seated position may be reached. The retention assembly 302 may further restrict rotational movement of the secondary medication chamber 204 by engaging complementary geometric features formed on an outer surface of the secondary medication chamber 204, including but not limited to flats, ribs, grooves, splines, and/or keyed surfaces.

The retention assembly 302 may maintain positional stability of the secondary medication chamber 204 during handling, transport, and/or oral use by resisting axial displacement and rotational misalignment. The retention assembly 302 may cooperate with the internal latch 304 to preserve seated engagement while permitting intentional disengagement during removal, according to one embodiment.

The internal latch 304 may be a mechanical engagement feature associated with the retention assembly 302 and positioned within the main body 102 adjacent to an insertion path of the secondary medication chamber 204. The internal latch 304 may include but not limited to a resilient arm, detent feature, spring-biased element, and/or deformable projection arranged to engage a corresponding surface of the secondary medication chamber 204.

The internal latch 304 may restrict axial withdrawal of the secondary medication chamber 204 after completion of insertion by engaging a shoulder, groove, flange, and/or recess formed on the secondary medication chamber 204. The internal latch 304 may contribute to rotational stabilization by maintaining engagement with alignment features of the secondary medication chamber 204 during oral use.

The internal latch 304 may permit controlled disengagement of the secondary medication chamber 204 upon application of a removal force exceeding a predetermined threshold. The internal latch 304 may maintain retention during normal handling and oral consumption while enabling removal for replacement and/or refilling under intentional conditions, according to one embodiment.

The distal end 306 may be a lower terminal region of the secondary medication chamber 204 positioned opposite an upper medication outlet region. The distal end 306 may include a base surface, flange, widened portion, and/or stop interface arranged for interaction with the retention assembly 302.

The distal end 306 may define a reference surface establishing axial insertion depth of the secondary medication chamber 204 within the main body 102. The distal end 306 may contact an axial stop portion of the retention assembly 302 to prevent further upward movement beyond a seated position.

The distal end 306 may cooperate with the internal latch 304 to maintain consistent axial positioning of the secondary medication chamber 204 relative to the primary fluid chamber 202. The distal end 306 may support repeatable alignment during insertion and removal cycles while preserving separation between medication and liquid prior to activation, according to one embodiment.

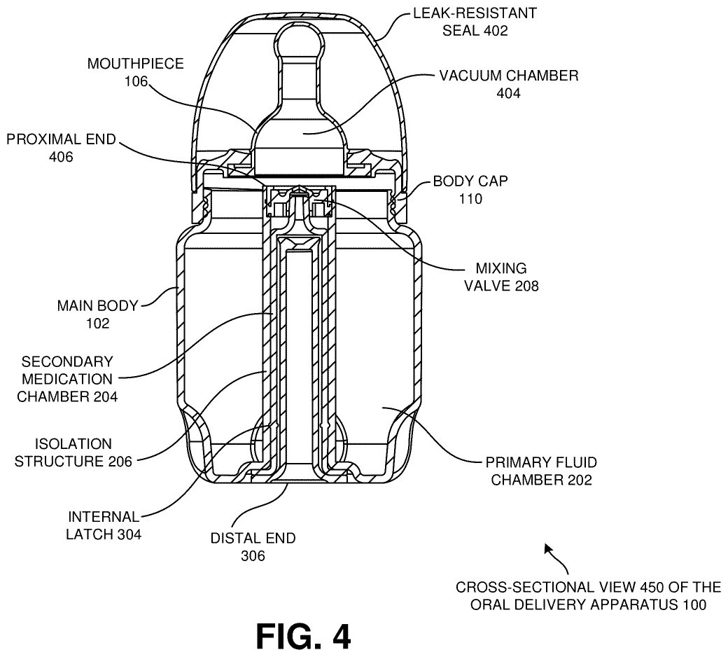

FIG. 4 is a cross-sectional view 450 of the oral delivery apparatus 100 showing a controlled mixing state in which a mixing valve 208 is positioned between the primary fluid chamber 202 and the secondary medication chamber 204, according to one embodiment. FIG. 4 illustrates the main body 102, the mouthpiece 106, the body cap 104, the primary fluid chamber 202, the secondary medication chamber 204, the isolation structure 206, the mixing valve 208, the retention assembly 302, the internal latch 304, the distal end 306, a leak-resistant seal 402, a vacuum chamber 404, and a proximal end 406, according to one embodiment.

The leak-resistant seal 402 may be a sealing interface positioned between the mouthpiece 106, the body cap 104, and adjacent internal components. The leak-resistant seal 402 may include elastomeric materials, compressive sealing surfaces, and/or circumferential sealing members arranged to limit fluid escape.

The leak-resistant seal 402 may restrict unintended leakage of liquid and/or medication during non-use, handling, transport, and oral consumption. The leak-resistant seal 402 may preserve separation between internal chambers by maintaining sealing contact around the mixing valve 208 and the vacuum chamber 404.

The leak-resistant seal 402 may cooperate with the vacuum chamber 404 to preserve pressure differentials generated during oral suction. The leak-resistant seal 402 may support controlled fluid pathways during oral use while maintaining isolation prior to activation, according to one embodiment.

The vacuum chamber 404 may be a pressure-responsive cavity positioned beneath the mouthpiece 106 and above the mixing valve 208. The vacuum chamber 404 may occupy a region defined by the body cap 104 and surrounding internal surfaces of the oral delivery apparatus 400.

The vacuum chamber 404 may experience a reduction in internal pressure during oral suction applied through the mouthpiece 106. The vacuum chamber 404 may transmit pressure changes toward the mixing valve 208, thereby influencing movement and/or actuation of the mixing valve 208 without external mechanical input.

The vacuum chamber 404 may cooperate with the proximal end 406 and the mixing valve 208 to support controlled transfer of medication during oral consumption. The vacuum chamber 404 may maintain pressure integrity through interaction with the leak-resistant seal 402, according to one embodiment.

In one embodiment, the mixing valve 208 comprises a pressure-responsive valve element positioned between the secondary medication chamber 204 and the primary fluid chamber 202 and biased toward a closed position during handling, storage, and non-use. Upon application of oral suction or pressure through the mouthpiece, a pressure differential is generated within a vacuum chamber adjacent the mixing valve, causing the valve element to move to an open position. In the open position, the mixing valve 208 establishes fluid communication between the secondary medication chamber 204 and the primary fluid chamber 202, permitting controlled release of medication into the consumable liquid. Upon cessation of suction or pressure, the valve element may return to the closed position to reestablish the non-mixing state.

The proximal end 406 may be an upper terminal portion of the secondary medication chamber 204 positioned along a longitudinal axis of the oral delivery apparatus 400. The proximal end 406 may occupy a location adjacent to the mixing valve 208 and beneath the body cap 104, forming an interface region between the secondary medication chamber 204 and upstream flow-control components.

The proximal end 406 may include an outlet surface and/or opening aligned with the mixing valve 208 to permit selective communication upon activation. The proximal end 406 may remain sealed during handling, storage, and/or transport to maintain separation between medication and liquid. The proximal end 406 may maintain positional alignment through cooperation with surrounding structural features of the main body 102 and the isolation structure 206.

The proximal end 406 may cooperate with pressure variations generated within the vacuum chamber 404 during oral use. The proximal end 406 may support controlled initiation of medication transfer by maintaining axial alignment with the mixing valve 208 while preserving isolation prior to activation, according to one embodiment.

Medication may be delivered through a dedicated internal conduit bypassing the primary fluid chamber 202, ensuring full dose delivery regardless of remaining liquid volume.

In one embodiment, the oral delivery apparatus 100 further comprises a dedicated internal conduit extending from the secondary medication chamber 204 toward a mixing region adjacent the mouthpiece 106, the conduit being physically isolated from the primary fluid chamber 202. The internal conduit is configured to deliver medication directly to the mixing region upon activation of the controlled mixing mechanism, thereby bypassing the primary fluid chamber 202. This configuration ensures delivery of an intended medication dose regardless of the volume of consumable liquid remaining in the primary fluid chamber 202, according to one embodiment.

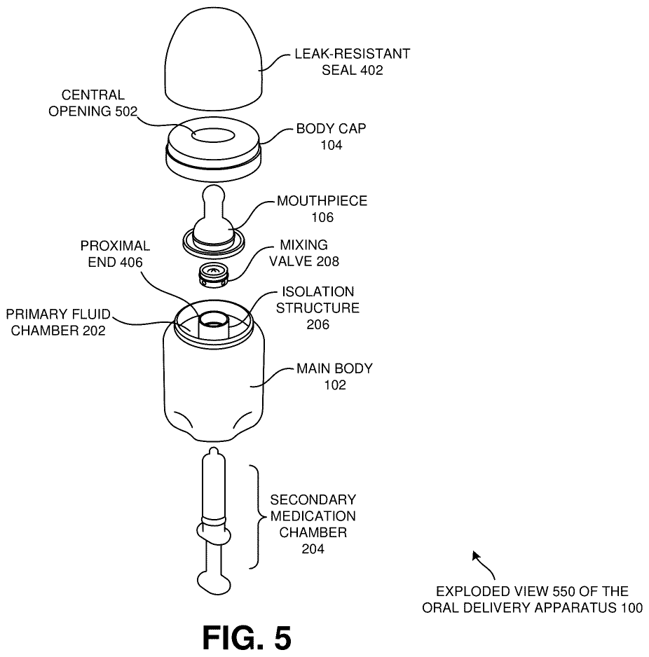

FIG. 5 is an exploded view 550 of the oral delivery apparatus 100 illustrating the interface between the body cap 104, the mouthpiece 106, the isolation structure 206, and the secondary medication chamber 204, according to one embodiment. FIG. 5 illustrates the oral delivery apparatus 100, the main body 102, the body cap 104, the mouthpiece 106, the secondary medication chamber 204, the isolation structure 206, the mixing valve 208, the leak-resistant seal 402, the proximal end 406, a central opening 502, according to one embodiment.

The central opening 502 may be an aperture extending through the body cap 104. The central opening 502 may present a substantially axial geometry oriented along a longitudinal axis of the oral delivery apparatus 100. The central opening 502 may include, but not be limited to, a circular, an oval, and/or a contoured perimeter shaped to receive at least a portion of the mouthpiece 106.

The central opening 502 may permit passage of the mouthpiece 106 and alignment of internal flow components positioned beneath the body cap 104. The central opening 502 may establish a controlled interface between an external oral access region and internal fluid pathways while limiting lateral displacement of components extending along the longitudinal axis.

The central opening 502 may engage the leak-resistant seal 402 along a peripheral edge region and may surround a base portion of the mouthpiece 106. The central opening 502 may maintain concentric alignment between the body cap 104, the mouthpiece 106, and the mixing valve 208 while preserving a sealed boundary between internal regions and an external environment, according to one embodiment.

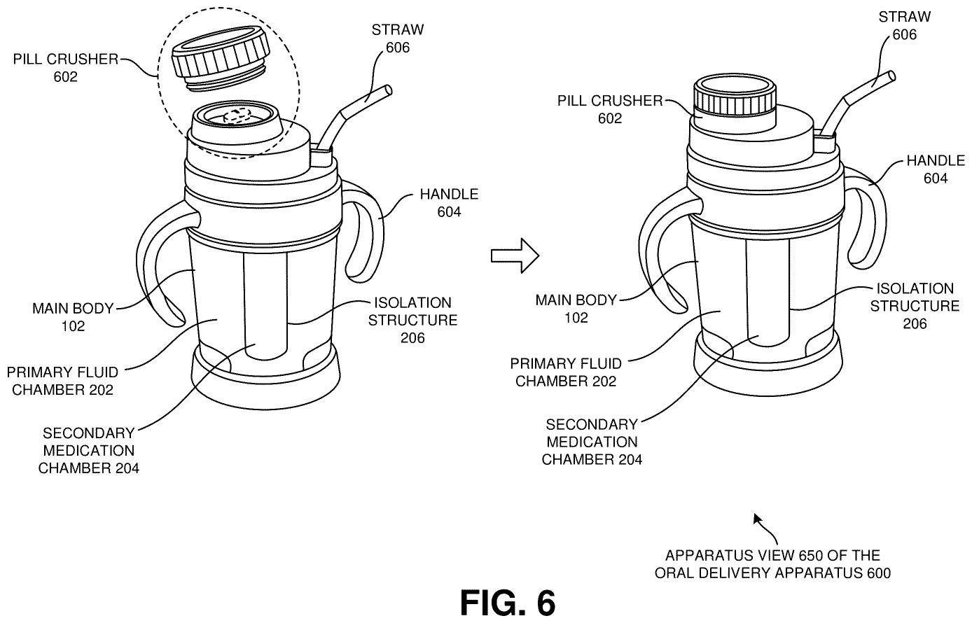

FIG. 6 is an apparatus view 650 of an oral delivery apparatus 600 illustrating a pill crusher 602 and a handle 604, according to one embodiment. FIG. 6 illustrates the main body 102, the primary fluid chamber 202, the secondary medication chamber 204, the isolation structure 206, a pill crusher 602, and a handle 604, according to one embodiment.

According to one embodiment, the oral delivery apparatus 100 may be an oral delivery apparatus 600 including the pill crusher 602 and the handle 604 to facilitate secure holding and stabilization of the oral delivery apparatus 100 during administration and/or consumption of the liquid. The pill crusher 602 may be integrated to an upper portion 904 of the oral delivery apparatus 600 and arranged to mechanically process a solid medication into a crushable form suitable for transfer into the secondary medication chamber prior to oral delivery. The oral delivery apparatus 600 may represent a variation of the oral delivery apparatus 100 incorporating an externally coupled grasping structure to improve handling, orientation control, and/or user comfort during medication preparation and oral administration

The pill crusher 602 may be a mechanical medication processing component positioned at an upper portion 904 of the oral delivery apparatus 600. The pill crusher 602 may include opposing crushing surfaces arranged to receive a solid medication, including but not limited to a tablet, a capsule, and/or a pill for size reduction and/or granulation prior to administration.

The pill crusher 602 may include opposing crushing surfaces formed on a rotatable cap and a stationary base arranged to apply compressive forces, shear forces, and/or torsional forces to a solid medication positioned between the crushing surfaces. The pill crusher 602 may include internal threads, ridges, teeth, textured surfaces, and/or abrasive interfaces configured to reduce a tablet, a capsule, and/or a pill into granular material, particulate material, and/or powdered material suitable for suspension in a liquid contained within the oral delivery apparatus 600.

In one embodiment, transfer of crushed medication from the pill crusher 602 into the secondary medication chamber 204 is facilitated by a gravity-assisted transfer interface positioned in axial alignment with the secondary medication chamber 204. The transfer interface may include a funnel, chute, or tapered passage defining a directed flow path from the pill crusher toward an inlet of the secondary medication chamber 204. The transfer interface may remain sealed from the primary fluid chamber 202 by the isolation structure and may be configured to open only during intentional medication loading, thereby limiting dispersion of crushed material and ensuring reliable delivery of the medication into the secondary medication chamber 204 prior to administration.

The pill crusher 602 may be integrated into an upper portion 904 of the oral delivery apparatus 600 and fixed relative to the main body 102 to permit medication crushing directly above the secondary medication chamber 204. Integrated attachment may include permanent mechanical coupling through molding, welding, adhesive bonding, overmolding, and/or unitary formation with the main body 102, thereby establishing a rigid structural relationship that maintains consistent axial alignment between the pill crusher 602 and the secondary medication chamber 204. Integrated positioning may reduce component count, limit misalignment during crushing, and preserve predictable medication transfer geometry while maintaining isolation from the primary fluid chamber 202, according to one embodiment.

In another embodiment, the pill crusher 602 may be detachably coupled to the oral delivery apparatus 600 through a mechanical engagement interface including a threaded interface, a snap-fit interface, a bayonet interface, and/or a detent interface, permitting selective separation of the pill crusher 602 from the main body 102. Detachable coupling may permit independent manipulation of the pill crusher 602 for medication processing, cleaning, replacement, and/or transfer of processed medication into the secondary medication chamber 204 through a dedicated transfer region while maintaining physical isolation from the primary fluid chamber 202. The detachable configuration may further permit secure reattachment of the pill crusher 602 in a predetermined axial and rotational orientation relative to the oral delivery apparatus 600 to preserve alignment with internal medication pathways, according to one embodiment.

The handle 604 may be a grasping structure coupled to an exterior surface of the main body 102. The handle 604 may extend laterally outward from the main body 102 to provide ergonomic support during handling and/or oral administration.

The handle 604 may include a plurality of arcuate members sized to accommodate a hand of a caregiver, a patient, and/or an animal handler. The handle 604 may include surface contours, texturing, and/or curvature configured to improve grip stability during medication preparation and delivery. The handle 604 may be configured as a single-sided handle extending from one side of the main body 102, wherein the handle 604 may define an open gap region between the handle and the main body 102 to permit insertion of fingers for grasping and lifting. In another embodiment, the handle 604 may be configured as a dual-sided handle arrangement including two opposing handles positioned on opposite sides of the main body 102, wherein each handle may include an open terminal end to permit grasping from a plurality of orientations.

The handle 604 may remain mechanically coupled to the main body 102 without interfering with the primary fluid chamber 202, the secondary medication chamber 204, and/or the isolation structure 206. The handle 604 may assist in stabilizing the oral delivery apparatus 600 during pill crushing, fluid consumption, and medication delivery, according to one embodiment.

In one embodiment, as shown in FIG. 6, the oral delivery apparatus 600 includes a straw 606 coupled to the lid and extending outwardly therefrom adjacent to the pill crusher 602. The straw 606 may be in fluid communication with the primary fluid chamber 202 and is configured to allow a user to drink liquid from the main body 102 while the pill crusher 602 is mounted to the lid. The straw 606 may be positioned laterally relative to the pill crusher 602 such that the lid accommodates the pill crusher without obstructing the drinking pathway. In this arrangement, liquid may be consumed through the straw 606 without removal or interference with the pill crusher 602.

The straw 606 may be an elongated drinking conduit coupled to the lid of the oral delivery apparatus adjacent to the pill crusher 602. The straw 606 may extend from an opening formed in the lid and provides a fluid communication path between the primary fluid chamber 202 and a user's mouth. The straw 606 may be positioned laterally offset from the pill crusher 602 such that the lid simultaneously accommodates the pill crusher while maintaining an unobstructed drinking pathway. In this configuration, a user may ingest liquid contents from the main body 102 through the straw 606 without removing or disengaging the pill crusher 602. The straw 606 may be fixed, pivotable, or selectively removable and may include a sealing interface with the lid to prevent leakage during use or transport, according to one embodiment.

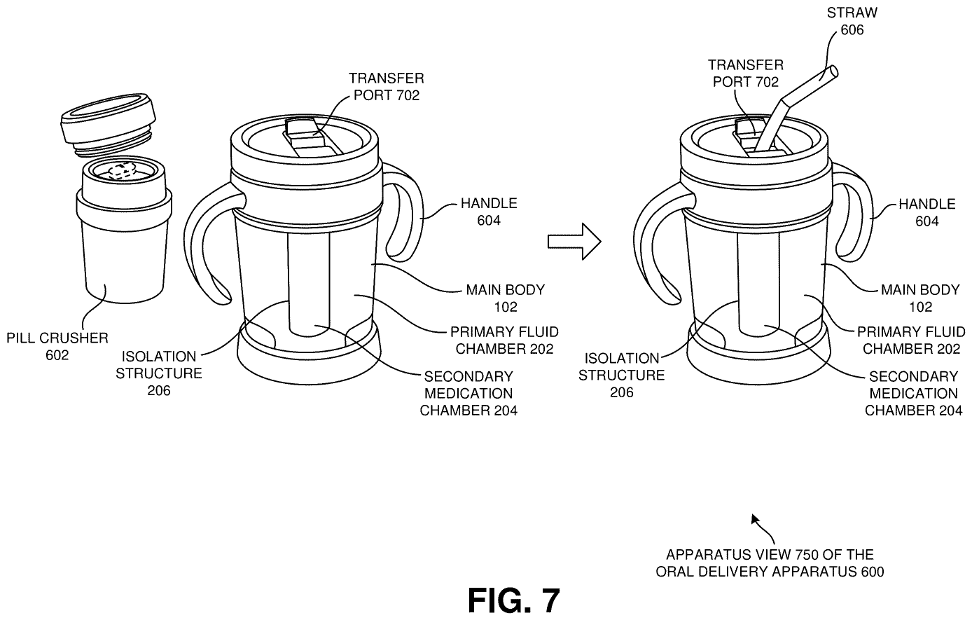

FIG. 7 is an apparatus view 750 of the oral delivery apparatus 600 illustrating the pill crusher 602 detached from the oral delivery apparatus 600, according to one embodiment. FIG. 7 illustrates the main body 102, the primary fluid chamber 202, the secondary medication chamber 204, the isolation structure 206, the pill crusher 602, the handle 604, and a transfer port 702, according to one embodiment.

According to one embodiment, the oral delivery apparatus 100 may be an oral delivery apparatus 600 including the transfer port 702 positioned at an upper region of the oral delivery apparatus 600. The transfer port 702 may be a dedicated access opening.

The transfer port 702 may be an access opening formed in an upper region of the oral delivery apparatus 600 and configured to receive processed medication from an external component. The transfer port 702 may define a bounded passage extending from an external access region toward the secondary medication chamber 204.

The transfer port 702 may include a defined perimeter, an internal lip, a channel, and/or a funnel geometry configured to guide particulate medication toward the secondary medication chamber 204 while limiting dispersion toward the primary fluid chamber 202. The transfer port 702 may further support controlled transfer of medication without disturbing the isolation structure 206.

The transfer port 702 may be positioned in axial alignment with the secondary medication chamber 204 and may remain physically isolated from the primary fluid chamber 202 by the isolation structure 206. The transfer port 702 may cooperate with the pill crusher 602 by receiving processed medication following detachment of the pill crusher 602 and directing the crushed medication into the secondary medication chamber 204, according to one embodiment.

As shown in FIG. 7, the oral delivery apparatus 600 may include a straw 606 configured for selective insertion through a transfer port 702 formed in the lid. The straw 606 may be positioned to extend through the transfer port 702 and into fluid communication with the primary fluid chamber 202, thereby providing a drinking pathway from the main body 102 to a user. In the illustrated configuration, the pill crusher 602 may be removed from the lid, and the straw 606 may occupy the transfer port 702, demonstrating an alternative drinking configuration of the apparatus. The transfer port 702 may enable modular use of the lid for medication preparation or liquid consumption, according to one embodiment.

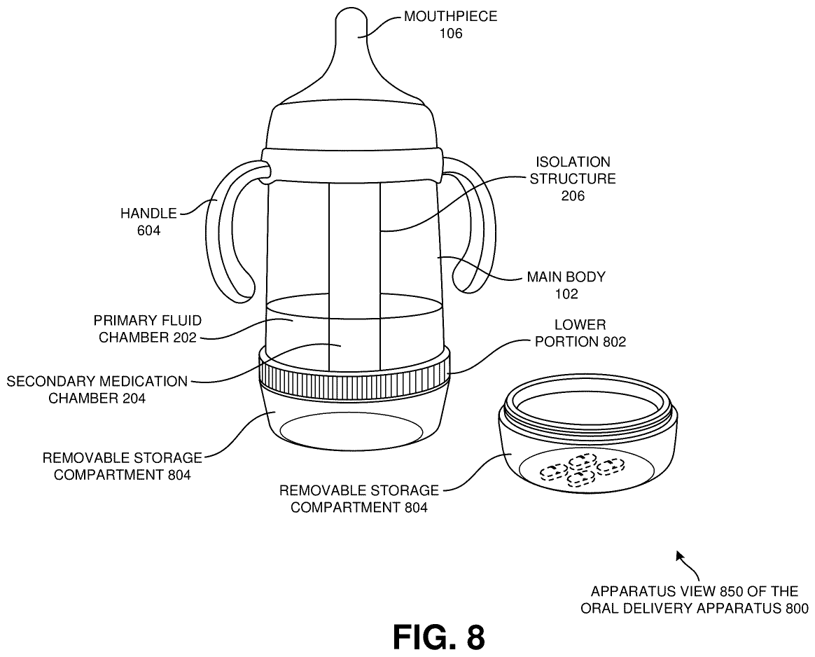

FIG. 8 is an apparatus view 850 of the oral delivery apparatus 800 illustrating a removable storage compartment 804 coupled to a lower portion 802 of a main body 102, according to one embodiment. FIG. 8 illustrates the main body 102, the mouthpiece 106, the primary fluid chamber 202, the secondary medication chamber 204, the isolation structure 206, the handle 604, a lower portion 802, and a removable storage compartment 804, according to one embodiment.

According to one embodiment, the oral delivery apparatus 100 may be an oral delivery apparatus 800 with the lower portion 802 and the removable storage compartment 804. The oral delivery apparatus 800 may define a structural configuration in which the lower portion 802 may be positioned beneath the primary fluid chamber 202. The removable storage compartment 804 may couple to the lower portion 802 to provide a dedicated storage.

The lower portion 802 may be a lower structural region of the oral delivery apparatus 800 positioned beneath the primary fluid chamber 202. The lower portion 802 may provide an external coupling interface for connection with a storage component.

The lower portion 802 may include a coupling feature, but not limited to threads, snap-fit features, bayonet features, detent features, and/or circumferential ribs arranged to engage a mating feature of the removable storage compartment 804. The lower portion 802 may include a sealing interface including but not limited to a gasket seat, a compressive flange, and/or a radial seal surface configured to limit ingress of contaminants and/or egress of stored contents.

The lower portion 802 may remain structurally associated with the main body 102 and separated from the primary fluid chamber 202 and the secondary medication chamber 204, thereby enabling storage access without disturbing the default non-mixing arrangement maintained by the isolation structure 206, according to one embodiment.

The removable storage compartment 804 may be a detachable storage container configured to selective coupling to the lower portion 802 of the oral delivery apparatus 800. The removable storage compartment 804 may include a base wall and a surrounding sidewall cooperating to provide an enclosed storage cavity for retaining including but not limited to medication, supplements, and/or consumable items.

The removable storage compartment 804 may include a coupling interface configured to engage a corresponding coupling interface of the lower portion 802 including but not limited a threaded coupling, a snap-fit coupling, a bayonet coupling, and/or a detent coupling. The removable storage compartment 804 may further include a sealing interface including but not limited to an elastomeric ring, a compressive lip, a friction-fit rim, and/or a planar sealing surface arranged to maintain retained contents during handling, transport, and/or storage.

The removable storage compartment 804 may retain stored contents in a region positioned below the primary fluid chamber 202 and below the secondary medication chamber 204, thereby maintaining physical separation between stored contents and oral delivery contents. The removable storage compartment 804 may support repeated cycles of detachment and reattachment relative to the lower portion 802 without altering positioning of the handle 604, the isolation structure 206, the primary fluid chamber 202, and the secondary medication chamber 204, according to one embodiment.

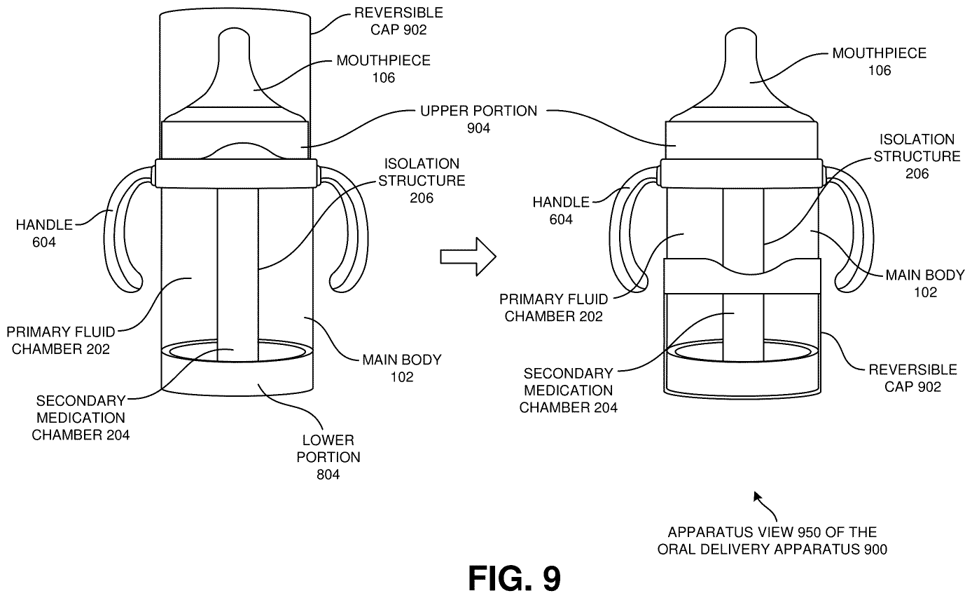

FIG. 9 is an apparatus view 950 of the oral delivery apparatus 900 illustrating a reversible cap 902 selectively coupled to an upper portion 904 and alternatively coupled to a lower portion 802 of the main body 102, according to one embodiment. FIG. 9 illustrates the main body 102, the mouthpiece 106, the primary fluid chamber 202, the secondary medication chamber 204, the isolation structure 206, the handle 604, the lower portion 802, a reversible cap 902, and an upper portion 904, according to one embodiment.

According to one embodiment, the oral delivery apparatus 100 may be an oral delivery apparatus 900 including the reversible cap 902 and the upper portion 904. The oral delivery apparatus 900 may include a structural configuration in which the reversible cap 902 may be selectively attachable to the upper portion 904 to enclose the mouthpiece 106 and alternatively attachable to a lower portion 804 to enclose a lower region of the main body 102.

The reversible cap 902 may be a physical closure component formed as a single body configured with multiple attachment orientations. The reversible cap 902 may include an internal cavity with a plurality of opposing coupling geometries positioned at different axial depths, enabling selective engagement with a plurality of region of the oral delivery apparatus 900.

The reversible cap 902 may provide a closure function by selectively enclosing either an upper region and/or a lower region of the oral delivery apparatus 900. Engagement with the upper portion 904 may result in enclosure of the mouthpiece 106 to limit exposure to contaminants and environmental contact. Engagement with the lower portion 802 may result in enclosure of a lower end of the oral delivery apparatus 900 to protect internal regions associated with medication containment and/or storage.

The reversible cap 902 may include a plurality of sealing structures positioned along internal surfaces, including a compressive rim, a gasket interface, a friction-fit surface, a snap-engagement feature, and/or combinations thereof. Structural coupling between the reversible cap 902 and the upper portion 904 and/or the lower portion 802 may occur through complementary interfaces aligned along a longitudinal axis, enabling secure attachment, removal, inversion, and/or reattachment while maintaining separation between internal chambers and the external environment, according to one embodiment.

The upper portion 904 may be a structural interface region positioned above the main body 102 and below the mouthpiece 106. The upper portion 904 may be formed as a circumferential collar, flange, and/or housing segment defining a transition region between internal chambers and an oral interface.

The upper portion 904 may provide a coupling and alignment function by supporting attachment of the reversible cap 902 in a first attachment orientation. The upper portion 904 may include but not limited to circumferential sealing surfaces, grooves, ridges, and/or shoulders arranged around the mouthpiece 106 to support closure engagement and positional stability.

The upper portion 904 may maintain structural continuity between the main body 102, internal flow components, and the mouthpiece 106. The upper portion 904 may remain aligned with internal chambers positioned below while cooperating with the reversible cap 902 to enclose, isolate, and protect the mouthpiece 106 without altering axial positioning and/or rotational orientation of internal components, according to one embodiment.

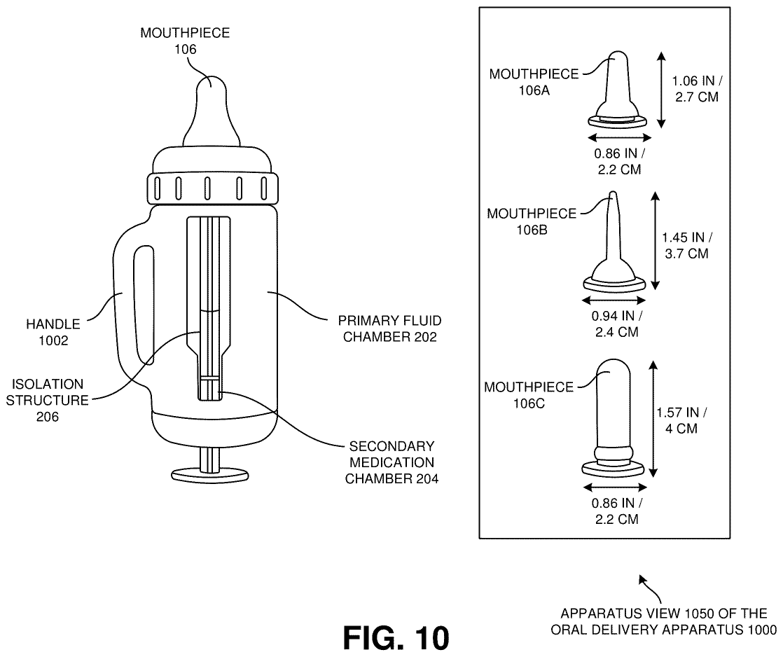

FIG. 10 is an apparatus view 1050 of the oral delivery apparatus 1000 illustrating, the mouthpiece 106, the primary fluid chamber 202, the secondary medication chamber 204, and a handle 1002, according to one embodiment. FIG. 10 illustrates the mouthpiece 106, the primary fluid chamber 202, the secondary medication chamber 204, the isolation structure 206, and a handle 1002, according to one embodiment.

According to one embodiment, the oral delivery apparatus 100 may be an oral delivery apparatus 1000 including the handle 1002 arranged within a vertically aligned body. The handle 1002 may be coupled to an exterior of the main body 102 to support controlled grasping, stabilization, and/or orientation of the oral delivery apparatus 1000 during oral administration to a human and/or an animal.

The handle 1002 may be a grasping and stabilization structure coupled to an exterior region of the main body 102. The handle 1002 may differ structurally and functionally from handle 604 by providing enhanced ergonomic control, improved load distribution, and increased adaptability across multiple user profiles.

The handle 1002 may include a plurality of elongated grip members extending laterally from the main body 102. Each grip member may include an open-ended geometry, a closed-loop geometry, and/or a partially open grasp profile enabling secure holding by a caregiver, a patient, and/or an animal handler. The handle 1002 may include surface texturing, curvature, spacing, and proportional scaling configured to support controlled manipulation across varying hand sizes, grip strengths, and handling orientations.

The handle 1002 may remain mechanically coupled to the main body 102 without intersecting the primary fluid chamber 202, the secondary medication chamber 204, and/or the isolation structure 206. The handle 1002 may further support a scalable structural design of the oral delivery apparatus 1000 by accommodating a plurality of dimensional variants associated with differing volumetric capacities of the primary fluid chamber 202, differing lengths and diameters of the secondary medication chamber 204, and differing ergonomic proportions of the mouthpiece 106. The dimensional variation may correspond to administration requirements associated with infants, children, adults, companion animals, livestock, and/or veterinary subjects of varying body mass and oral anatomy, while preserving consistent functional architecture including the isolation structure 206, the controlled mixing mechanism, and the retention assembly 302 to maintain predictable non-mixing behavior, controlled dosing alignment, and fixed axial and rotational positioning across plurality of variants, according to one embodiment.

As shown in FIG. 10, the oral delivery apparatus 1000 includes a mouthpiece 106 configured as an animal administration nipple for dispensing fluid to an animal. The apparatus may further include a primary fluid chamber 202, a secondary medication chamber 204, and an isolation structure 206 separating the chambers. The mouthpiece 106 may be coupled to an upper portion of the apparatus and is configured to be engaged by an animal during drinking, according to one embodiment.

In another embodiment, FIG. 10 further illustrates multiple example nipple configurations for mouthpiece(s) 106A, 106B, and 106C, each having different shapes, lengths, and outlet geometries. These nipple variations are representative of administration nipples adapted for different animal species, sizes, or feeding behaviors. For example, the nipple configurations may differ in overall height, base diameter, taper profile, flexibility, and flow characteristics. The illustrated dimensional variations demonstrate that the oral delivery apparatus 1000 may be configured with interchangeable or selectable nipples to accommodate a wide range of animals while maintaining fluid communication with the primary fluid chamber 202.

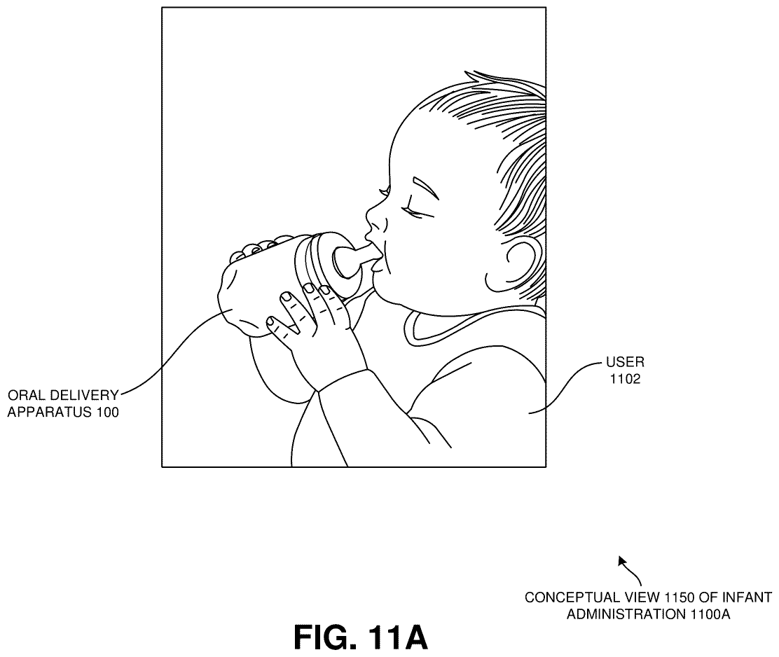

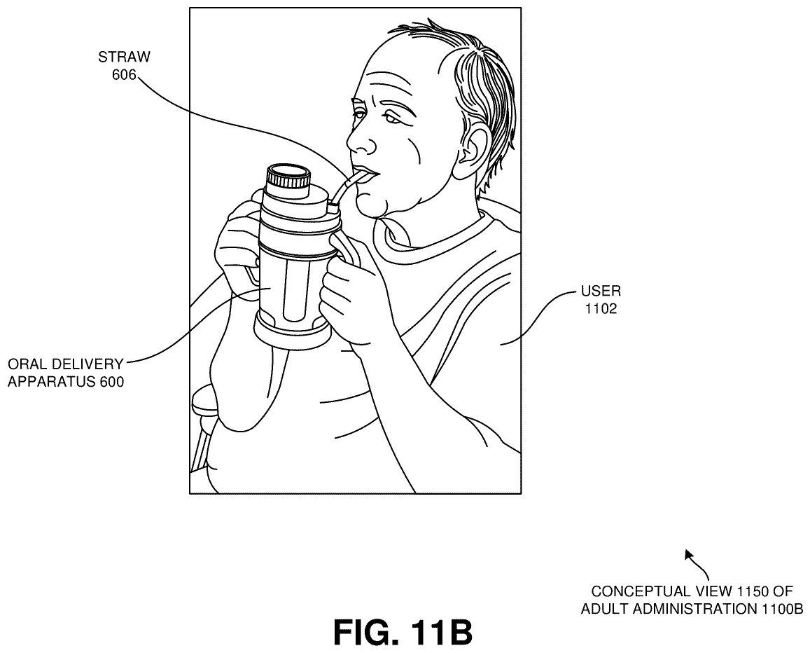

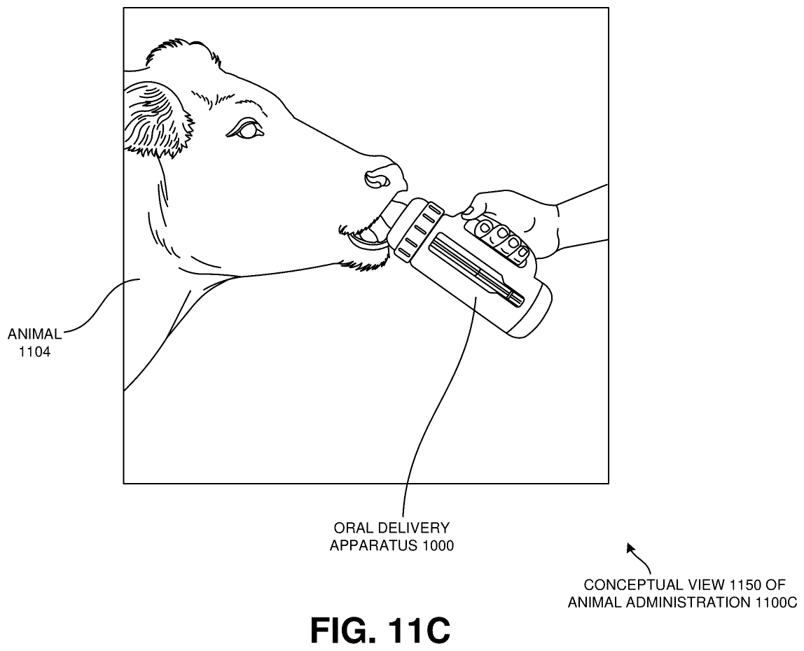

FIG. 11A is a conceptual view 1150 illustrating an infant administration 1100A use case of the oral delivery apparatus 100 of FIG. 1, according to one embodiment. FIG. 11A illustrates the oral delivery apparatus 100, according to one embodiment.

The infant administration 1100A may represent a use in which the oral delivery apparatus 100 engages an infant mouth for consumption of liquid and medication. The infant administration 1100A may include positioning of the oral delivery apparatus 100 at an angle appropriate for infant (e.g., user 1102) feeding while maintaining internal isolation between liquid and medication prior to activation.

The infant administration 1100A may permit controlled initiation of fluid flow through oral suction applied by the infant. The infant administration 1100A may support synchronized delivery of liquid and medication following activation of internal mixing mechanisms while preserving predictable dosing alignment.

The infant administration 1100A may further support caregiver-assisted control of orientation, stability, and pacing while allowing the infant user 1102 to engage naturally with the mouthpiece. The infant administration 1100A may thereby enable safe and controlled oral delivery of medication and liquid to an infant population, according to one embodiment.

FIG. 11B is a conceptual view 1150 illustrating an adult administration 1100B use case of the oral delivery apparatus 100 of FIG. 1, according to one embodiment. FIG. 11B illustrates the oral delivery apparatus 100, according to one embodiment.

The adult administration 1100B may represent a use in which the oral delivery apparatus 100 engages an adult mouth for direct oral intake. The adult administration 1100B may include positioning of the oral delivery apparatus 100 by the adult user 1102 to align the mouthpiece with oral anatomy while maintaining internal chamber orientation.

The adult administration 1100B may permit activation of a controlled mixing mechanism through application of oral suction, pressure, and/or manual handling forces generated by the adult user. The adult administration 1100B may support controlled transfer of medication from the secondary medication chamber into the primary fluid chamber while maintaining dosing alignment.

The adult administration 1100B may further support repeated administration cycles, variable dosing volumes, and independent user control without caregiver assistance. The adult administration 1100B may thereby enable reliable oral delivery of medication and liquid to adult users across therapeutic, nutritional, and/or hydration contexts, according to one embodiment.

As shown in FIG. 11B, an oral delivery apparatus 600 is illustrated in use by an elderly adult user 1102 drinking liquid from the apparatus via a straw 606 or mag-slider drinking interface coupled to the lid. The apparatus may be held in an upright orientation, and the user 1102 accesses the liquid without the need to tilt the cup or engage a nipple-style mouthpiece. This configuration is particularly suitable for elderly users 1102 who may experience reduced hand strength, limited range of motion, or difficulty coordinating conventional drinking actions. FIG. 11B demonstrates an adult administration embodiment in which the oral delivery apparatus 600 provides an accessible drinking interface optimized for elderly use while maintaining controlled delivery of liquid and/or medication, according to one embodiment.

FIG. 11C is a conceptual view 1150 illustrating an animal administration 1100C use case of the oral delivery apparatus 1000 of FIG. 10, according to one embodiment. FIG. 11C illustrates the oral delivery apparatus 1000, according to one embodiment.

The animal administration 1100C may represent a use in which the oral delivery apparatus 1000 engages an animal mouth under guidance of a handler. The animal administration 1100C may include positioning of a mouthpiece adjacent an oral opening of the animal 1104 while maintaining axial alignment of internal chambers.

The animal administration 1100C may permit activation of a controlled mixing mechanism through applied pressure, induced suction, and/or manual compression generated by interaction between the animal 1104 and the oral delivery apparatus 1000. The animal administration 1100C may support controlled transfer of medication into a consumable liquid while maintaining isolation prior to activation.

The animal administration 1100C may enable delivery of medication to animals exhibiting varying cooperation levels, jaw strength, and oral geometry. The animal administration 1100C may thereby support veterinary dosing, nutritional supplementation, hydration, and therapeutic administration across a wide range of non-human animal species, according to one embodiment.

A number of embodiments have been described. Nevertheless, it will be understood that various modifications may be made without departing from the spirit and scope of the claimed invention. Although the embodiments described herein are presented with reference to specific example configurations, various modifications, substitutions, and structural variations may be made without departing from the broader spirit and scope of the invention. The components, assemblies, and subassemblies disclosed herein may be formed, arranged, and combined in different configurations while maintaining the functional principles described in the claims.

The oral delivery apparatus, including associated chambers, isolation structures, valves, retention assemblies, caps, handles, and medication processing components, may be manufactured using a variety of materials, fabrication techniques, and mechanical interfaces suitable for oral delivery applications. Structural elements may be integrally formed, separable, removable, reversible, or reconfigurable, and may incorporate mechanical fasteners, interference fits, resilient members, seals, and alignment features as appropriate.

The operations and interactions described herein, including isolation of medication, controlled mixing, retention, sealing, and oral administration, are illustrative of functional relationships between physical components and do not require a specific sequence or orientation unless expressly stated. Certain steps or interactions may be combined, reordered, repeated, or omitted, and additional components may be incorporated without departing from the scope of the claimed invention.

The figures depict example embodiments in which structures are shown as distinct for clarity. In practice, one or more structures may be combined, subdivided, or configured to perform overlapping functions. Connections and interactions not explicitly shown may exist, and illustrated arrangements are not intended to limit structural or functional relationships.

Accordingly, the specification and drawings are to be regarded in an illustrative rather than restrictive sense, and all such variations, modifications, and alternative embodiments fall within the scope of the appended claims.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

1. An oral delivery apparatus comprising,
a primary fluid chamber to contain a consumable liquid;
a secondary medication chamber to contain a medication, the secondary medication chamber is physically isolated from the primary fluid chamber;
an isolation structure positioned between the primary fluid chamber and the secondary medication chamber, the isolation structure maintaining a default non-mixing state during handling;
a controlled mixing mechanism operatively associated with the isolation structure, the controlled mixing mechanism to establish fluid communication between the primary fluid chamber and the secondary medication chamber upon activation of the controlled mixing mechanism;
a retention assembly associated with the secondary medication chamber to maintain the secondary medication chamber in a fixed axial position and a fixed rotational orientation relative to the oral delivery apparatus during use; and
a mouthpiece positioned at an upper portion of the oral delivery apparatus configured to be received in a mouth of a user to deliver consumable liquid for oral consumption.

2. The oral delivery apparatus of claim 1,
wherein the isolation structure comprises a physical barrier preventing contact between the medication and the consumable liquid prior to activation of the controlled mixing mechanism.

3. The oral delivery apparatus of claim 1,
wherein the controlled mixing mechanism comprises at least one of a suction-responsive mechanism, a pressure-responsive mechanism, and a mechanical release mechanism, and
wherein the controlled mixing mechanism comprises a mixing valve positioned between the primary fluid chamber and the secondary medication chamber.

4. The oral delivery apparatus of claim 3,
wherein the mixing valve remains closed prior to activation and opens upon activation to permit controlled transfer of the medication.

5. The oral delivery apparatus of claim 1,
wherein the retention assembly comprises an axial stop limiting insertion depth of the secondary medication chamber,
wherein the retention assembly comprises a rotational alignment feature preventing misorientation of the secondary medication chamber, and
wherein the retention assembly comprises a locking interface selected from a snap-fit interface, a threaded interface, a bayonet interface, and a detent interface.

6. The oral delivery apparatus of claim 1,
wherein the secondary medication chamber is removable and replaceable independently of the primary fluid chamber.

7. The oral delivery apparatus of claim 1,
wherein the oral delivery apparatus comprises a leak-resistant seal to maintain the default non-mixing state during non-use.

8. The oral delivery apparatus of claim 1, further comprising:
a pill crusher positioned on the oral delivery apparatus and arranged to mechanically crush a solid medication prior to placement within the secondary medication chamber.

9. The oral delivery apparatus of claim 8,
wherein the pill crusher is detachable from the oral delivery apparatus to transfer crushed medication into the secondary medication chamber through a transfer port.

10. The oral delivery apparatus of claim 8,
wherein the pill crusher is integrated into the upper portion of the oral delivery apparatus.

11. The oral delivery apparatus of claim 1,
wherein the secondary medication chamber is in fluid communication with an internal conduit configured to deliver the medication toward a mixing region adjacent the mouthpiece while bypassing the primary fluid chamber, and
wherein the internal conduit and the controlled mixing mechanism are configured to deliver an intended dose of the medication independently of a remaining volume of the consumable liquid in the primary fluid chamber.

12. A method of administering a medication during oral consumption of a liquid, comprising:
maintaining a medication within a secondary medication chamber physically isolated from a primary fluid chamber of an oral delivery apparatus;
preserving a default non-mixing state between the medication and the liquid during handling;
activating a controlled mixing mechanism in response to oral consumption to establish fluid communication between the secondary medication chamber and the primary fluid chamber; and
delivering the medication together with the liquid following activation while maintaining the secondary medication chamber in a fixed axial position and a fixed rotational orientation relative to the oral delivery apparatus.

13. The method of claim 12,
wherein activating the controlled mixing mechanism comprises generating oral suction through a mouthpiece of the oral delivery apparatus, and
wherein activating the controlled mixing mechanism comprises applying pressure to the oral delivery apparatus during oral consumption.

14. The method of claim 12,
wherein preserving the default non-mixing state comprises preventing fluid communication through a mixing valve prior to activation of the controlled mixing mechanism,
wherein delivering the medication occurs in a controlled dose synchronized with activation of the controlled mixing mechanism during oral consumption of the liquid, and
wherein maintaining the secondary medication chamber in the fixed axial position and the fixed rotational orientation comprises mechanically restraining the secondary medication chamber relative to the oral delivery apparatus throughout activation and delivery of the medication.

15. The method of claim 12, further comprising:
mechanically crushing a solid medication using a pill crusher prior to transferring the medication into the secondary medication chamber.

16. An oral delivery apparatus comprising:
a primary fluid chamber to contain a consumable liquid;
a secondary medication chamber to contain a medication, and the secondary medication chamber is physically isolated from the primary fluid chamber;
a pill crusher to mechanically crush a solid medication prior to transfer of crushed medication into the secondary medication chamber;
an isolation structure positioned between the primary fluid chamber and the secondary medication chamber, the isolation structure maintaining a default non-mixing state during handling;
a controlled mixing mechanism comprising a mixing valve positioned between the primary fluid chamber and the secondary medication chamber operatively associated with the isolation structure to establish fluid communication between the primary fluid chamber and the secondary medication chamber upon activation; and
a retention assembly associated with the secondary medication chamber to maintain the secondary medication chamber in a fixed axial position and a fixed rotational orientation relative to the oral delivery apparatus during use.

17. The oral delivery apparatus of claim 16,
wherein the pill crusher comprises an integrated structure to an upper portion of the oral delivery apparatus, and
wherein the pill crusher comprises a detachable structure separable from the oral delivery apparatus to transfer crushed medication into the secondary medication chamber.

18. The oral delivery apparatus of claim 16,
wherein the oral delivery apparatus further comprises a removable storage compartment coupled to a lower portion of the oral delivery apparatus by at least one of a threaded coupling, a snap-fit coupling, a bayonet coupling, and a detent coupling to store medication prior to administration, and
wherein the oral delivery apparatus further comprises a reversible cap selectively attachable to an upper portion and a lower portion of the oral delivery apparatus by at least one of threaded interface, snap-fit interface, bayonet interface, and detent interface for storage, sealing and sanitation.

19. The oral delivery apparatus of claim 16,
wherein the mixing valve of the controlled mixing mechanism remains closed to prevent fluid communication between the primary fluid chamber and the secondary medication chamber during storage, handling, and transport, and opens only upon activation to permit transfer of the medication,
wherein the retention assembly comprises an axial stop limiting insertion depth of the secondary medication chamber and a rotational alignment feature preventing rotation of the secondary medication chamber relative to the oral delivery apparatus during use, and
wherein the secondary medication chamber is removable from the oral delivery apparatus while the isolation structure maintains the default non-mixing state, thereby preventing contact between the medication and the consumable liquid during removal and replacement of the secondary medication chamber.

20. The oral delivery apparatus of claim 16, further comprising:
a handle coupled to the oral delivery apparatus to permit controlled positioning and stabilization of the oral delivery apparatus during oral administration to a human and an animal.

21. The oral delivery apparatus of claim 16,
wherein the secondary medication chamber comprises a custom syringe assembly, the custom syringe assembly comprises at least one of a volume, a geometry, and a dispensing profile for oral administration to the human and the animal.
